(19) United States
(12) Patent Application Publication
(10) Pub. No.: US 2023/0290356 A1
(43) Pub. Date: Sep. 14, 2023

(54) HEARING AID FOR COGNITIVE HELP USING SPEAKER RECOGNITION

(71) Applicant: Sony Group Corporation, Tokyo (JP)

(72) Inventors: Brant Candelore, Poway, CA (US); Mahyar Nejat, La Jolla, CA (US)

(73) Assignee: Sony Group Corporation, Tokyo (JP)

(21) Appl. No.: 17/693,145

(22) Filed: Mar. 11, 2022

(51) Int. Cl. G10L 17/18; H04R 25/02; G06F 16/632

(52) U.S. Cl. CPC G10L 17/18; H04R 25/02; G06F 16/634

(57) ABSTRACT

Implementations generally relate to hearing aids. In some implementations, a method includes receiving sound at a hearing aid. The method further includes detecting a voice from the sound. The method further includes identifying the voice. The method further includes providing identity information associated with the voice.

### CROSS REFERENCE TO RELATED APPLICATIONS

This application is related to U.S. patent application Ser. No. ______, entitled “HEARING AID FOR ALARMS AND OTHER SOUNDS,” filed Feb. ______, 2022 (Attorney Docket No. 020699-119500US/Client Reference No. SYP346746US01), and U.S. patent application Ser. No. ______, entitled “HEARING AID IN-EAR ANNOUNCEMENTS,” filed Feb. ______, 2022 (Attorney Docket No. 020699-119600US/Client Reference No. SYP346747US01), which is hereby incorporated by reference as if set forth in full in this application for all purposes.

### BACKGROUND

Some people deal with deterioration of hearing due to aging. Hearing aids can assist such people by capturing, processing, and amplifying sound that passes to the user's ear canals. Some hearing aids have been miniaturized to the point that they can sit directly in the user's ear canal and are almost invisible to others. Hearing aids pick up and amplify sounds to a level that the user can hear.

### SUMMARY

Implementations generally relate to hearing aids. In some implementations, a system includes one or more processors, and includes logic encoded in one or more non-transitory computer-readable storage media for execution by the one or more processors. When executed, the logic is operable to cause the one or more processors to perform operations including: determining characterization information from the voice; matching the characterization information from the voice to characterization information in a database; and identifying a person based on the matching.

With further regard to the system, in some implementations, the logic when executed is further operable to cause the one or more processors to perform operations comprising: determining characterization information from the voice; matching the characterization information from the voice to characterization information in a database; and identifying a person based on the matching. In some implementations, the logic when executed is further operable to cause the one or more processors to perform operations comprising: detecting a plurality of voices from the sound; identifying a primary voice from the plurality of voices; and providing the identity information, wherein the identity information is associated with the primary voice. In some implementations, the logic when executed is further operable to cause the one or more processors to perform operations comprising: generating a notification that identifies a person associated with the voice, wherein the notification comprises the identity information; and providing the identity information in the notification. In some implementations, the identity information is provided in an in-ear notification, wherein the in-ear notification is audible to a user of the hearing aid. In some implementations, the logic when executed is further operable to cause the one or more processors to perform operations comprising: establishing communication between the hearing aid and a mobile device; and accessing an Internet via the mobile device, wherein the hearing aid sends and receives data to and from the Internet via the mobile device. In some implementations, the logic when executed is further operable to cause the one or more processors to perform operations comprising identifying one or more voices from the sound in real time based on artificial intelligence.

In some implementations, a non-transitory computer-readable storage medium with program instructions thereon is provided. When executed by one or more processors, the instructions are operable to cause the one or more processors to perform operations including: determining characterization information from the voice; matching the characterization information from the voice to characterization information in a database; and identifying a person based on the matching.

With further regard to the computer-readable storage medium, in some implementations, the instructions when executed are further operable to cause the one or more processors to perform operations comprising: determining characterization information from the voice; matching the characterization information from the voice to characterization information in a database; and identifying a person based on the matching. In some implementations, the instructions when executed are further operable to cause the one or more processors to perform operations comprising: detecting a plurality of voices from the sound; identifying a primary voice from the plurality of voices; and providing the identity information, wherein the identity information is associated with the primary voice. In some implementations, the instructions when executed are further operable to cause the one or more processors to perform operations comprising: generating a notification that identifies a person associated with the voice, wherein the notification comprises the identity information; and providing the identity information in the notification. In some implementations, the identity information is provided in an in-ear notification, wherein the in-ear notification is audible to a user of the hearing aid. In some implementations, the instructions when executed are further operable to cause the one or more processors to perform operations comprising: establishing communication between the hearing aid and a mobile device; and accessing an Internet via the mobile device, wherein the hearing aid sends and receives data to and from the Internet via the mobile device. In some implementations, the instructions when executed are further operable to cause the one or more processors to perform operations comprising identifying one or more voices from the sound in real time based on artificial intelligence.

In some implementations, a method includes: determining characterization information from the voice; matching the characterization information from the voice to characterization information in a database; and identifying a person based on the matching.

With further regard to the method, in some implementations, the method further includes: determining characterization information from the voice; matching the characterization information from the voice to characterization information in a database; and identifying a person based on the matching. In some implementations, the method further includes: detecting a plurality of voices from the sound; identifying a primary voice from the plurality of voices; and providing the identity information, wherein the identity information is associated with the primary voice. In some implementations, the method further includes: generating a notification that identifies a person associated with the voice, wherein the notification comprises the identity information; and providing the identity information in the notification. In some implementations, the identity information is provided in an in-ear notification, wherein the in-ear notification is audible to a user of the hearing aid. In some implementations, the method further includes: establishing communication between the hearing aid and a mobile device; and accessing an Internet via the mobile device, wherein the hearing aid sends and receives data to and from the Internet via the mobile device.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example hearing aid and environment for providing cognitive help using speaker recognition, which may be used for implementations described herein.

FIG. 2A is an image of an example hearing aid, which may be used for implementations described herein.

FIG. 2B is an image of a hearing aid worn on an ear, according to some implementations.

FIG. 3A is an image of an example hearing aid, which may be used for implementations described herein.

FIG. 3B is an image of a hearing aid worn in the canal of an ear, according to some implementations.

FIG. 4 is an example flow diagram for providing cognitive help using a hearing aid and speaker recognition, according to some implementations.

FIG. 5 is a block diagram of an example network environment, which may be used for some implementations described herein.

FIG. 6 is a block diagram of an example computer system, which may be used for some implementations described herein.

### DETAILED DESCRIPTION

Implementations generally relate to hearing aids, and, in particular hearing aids that provide cognitive help using speaker recognition. As described in more detail herein, in various implementations, a system receives sound at a hearing aid. The system further detects a voice from the sound. The system further identifies the voice. The system further provides identity information associated with the voice.

Implementations enable the user to receive such identity information in real-time as the user speaks with other people while at home or elsewhere (e.g., around town, etc.). In various implementations, the system may automatically provide identity information of the person speaking with the wearer of a hearing aid. In some scenarios, where the hearing aid is worn over an ear, the user/hearing aid wearer may tap the hearing aid a number of times to initiate an identity process or initiate an announcement of the identity of the person speaking. In other scenarios, the wearer may be able to speak to the hearing aid a command such as “identity” or “identify.” If using a smart device for control, the wearer may use a user interface on the smart device to get the identity information, which can be announced through the hearing aids. In various implementations, the system provides in-ear notifications containing the identity information so that the user of the hearing aid hears the identity information and other people in proximity do not hear the identity information. This discreetly notifies the user without disturbing other people or interrupting conversation between the user and others, etc.

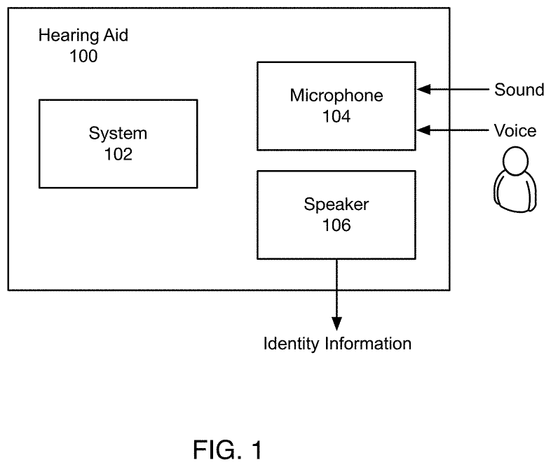

FIG. 1 is a block diagram of an example hearing aid 100 and environment for providing cognitive help using speaker recognition, which may be used for implementations described herein. As shown, the environment includes hearing aid 100, which includes a system 102, a microphone 104, and a speaker 106.

In various implementations, system 102 of hearing aid 100 may communicate with the Internet directly or via a mobile device such as a smart phone, computer, etc. By enabling hearing aid 100 to be tethered to a mobile device that connects to the Internet or other network, hearing aid 100 may continually stream audio to the Internet for analysis by a web server. System 102 may communicate with the Internet or with another device such as a mobile device via any suitable communication network such as a Bluetooth network, a Wi-Fi network, etc.

As described in more detail herein, system 102 of hearing aid 100 receives outside sounds, which include various types of sounds from the ambient environment. The hearing aid 100 generally amplifies and/or may attenuate detected sounds according to implementations described herein. Detected sounds may include various types of sounds from the ambient environment, including a voice from a person or voices from people in proximity to a user wearing hearing aid 100. In various implementations, system 102 provides identity information associated with each of one or more detected voices.

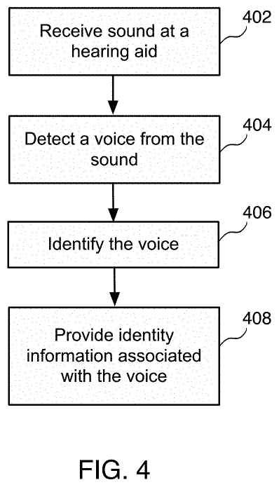

In some implementations, system 102 attenuates detected sounds in order to enable the user wearing hearing aid 100 to better hear any identity information provided by system 102. Further implementations directed to operations of hearing aid 100 are described in more detail herein, in connection with FIG. 4, for example.

For ease of illustration, FIG. 1 shows one block for each of system 102, microphone 104, and speaker 106. Blocks 102, 104, and 106 may represent multiple systems, microphones, and speakers, depending on the particular implementation. In other implementations, hearing aid 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

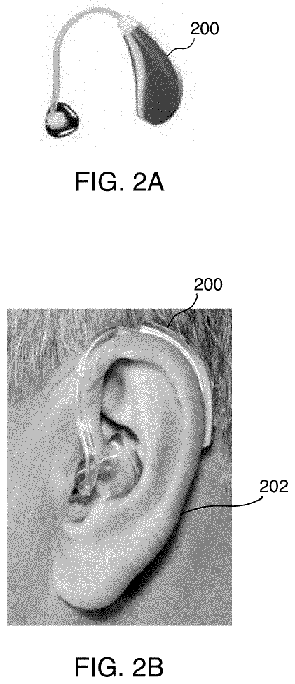

FIG. 2A is an image of an example hearing aid 200, which may be used for implementations described herein. FIG. 2B is an image of hearing aid 200 worn on an ear 202, according to some implementations. As shown, hearing aid 200 is worn on the exterior of ear 202 and wraps around the top of ear 202. In various implementation, the hearing aid receiver inserts into the canal of an ear.

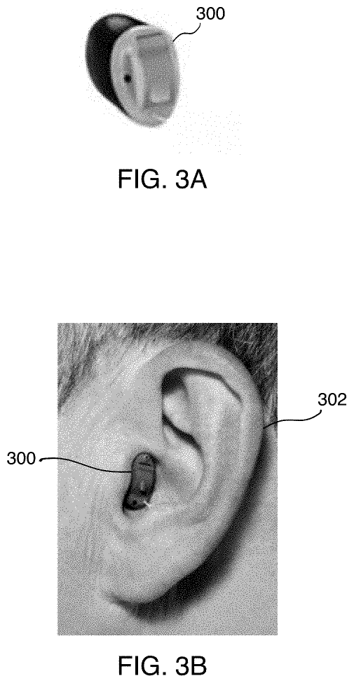

FIG. 3A is an image of an example hearing aid 300, which may be used for implementations described herein. FIG. 3B is an image of hearing aid 300 worn in the canal of an ear 302, according to some implementations. As shown, hearing aid 300 being inserted in the canal of ear 302 is less visible. The hearing aids shown in FIGS. 2A, 2B, 3A, and 3B are example implementations of hearing aid hardware. The particular types of hearing aid hardware may vary, depending on the implementation.

FIG. 4 is an example flow diagram for providing cognitive help using a hearing aid and speaker recognition, according to some implementations. Referring to both FIGS. 1 and 2, a method is initiated at block 402, where a system such as system 102 receives sound at a hearing aid.

At block 404, the system detects a voice from the sound. For example, the system may detect various types of sounds such as traffic, a dog barking, a voice, etc.

At block 406, the system identifies the voice. In various implementations, to identify the voice, the system determines characterization information from the voice. The characterization information may include various qualities of the voice, which may include timbre, pitch, volume, etc. The particular qualities may vary, depending on the implementation. The system may utilize suitable characterization techniques to collect the characterization information. The system then matches the characterization information from the voice to characterization information in a database. The system then identifies a person based the matching.

In an example scenario, the system may identify the voice as the daughter of the user, or other known person (e.g., other family member, friend, etc.). The system providing the identity information to the user assists the user in the scenario where the user has cognitive issues (e.g., cognitive issues related to aging, accidents, etc.), where the user has short-term memory challenges. In some implementations, the hearing aid may also receive information (e.g., caller identification) from a mobile device such as a smart phone to help set up voice recognition for useful phone contacts.

The system providing the identity information to the user also avoids a scenario where a stranger or imposter claims to be a different person. In such a scenario where there is an imposter, the user might hear the daughter's name (e.g., “It's Kate.”), where the system does not recognize a voice that matches the daughter. In some implementations, the system may indicate to the user that there is a name mismatch. As such, the user may take action accordingly.

In various implementations, the system identifies one or more voices from the sound in real time based on artificial intelligence and machine learning. The system may also identify one or more voices from the sound in advance based on artificial intelligence and machine learning. For example, the user may ask a given speaker to say a series of words (e.g., read text or isolated vocabulary, etc.) into the system. The system may be trained in advance of a conversation or may analyze a given voice in real-time during a conversation to recognize the specific voice or to fine-tune the recognition of the voice, resulting in increased accuracy.

At block 408, the system provides identity information associated with the voice. In the scenario above, after the system identifies the voice (e.g., the voice of the daughter, etc.), the system provides the identity information associated with the voice. In various implementations, the system provides the identity information in an in-ear notification. As such, the in-ear notification is audible to a user of the hearing aid and not audible to the other person. As such, the user may learn of the person associated with the voice discreetly.

The system may detect multiple voices from the sound. This may be a scenario where there are multiple conversations with and without the involvement of the user. In some implementations, the system may identify a primary voice from the multiple voices. In some implementations, the system may determine the primary voice based on various factors. Such factors may include the volume of the voice, the location of the voice, etc. For example, the primary voice may be the loudest voice. In another example, the primary voice may be a voice that originates in front of the user. The system may determine that a voice is in front of the user based on the two hearing aids detecting a similar volume of the voice, where the other person is standing directly in front of the user. In some implementations, the direction of the microphones of the hearing aids may also determine whether the source of the voice is in front of the user versus behind the user. After the system identifies the primary voice, the system may then recognize the voice based on a suitable voice recognition technique, and then provide the identity information to the user, where the identity information is associated with the primary voice.

In various implementations, the system generates a notification that identifies a person associated with the voice, where the notification includes the identity information. In some implementations, the notification may include other information in addition to the identity information. For example, in some implementations, the system may provide biographical information. This may be useful where the user is an acquaintance of the speaker, and where the system indicates in the notification how the user knows the speaker, job title of the speaker, significant family members of the speaker, etc. The system provides the identity information and any other relevant information associated with the other person in the notification.

In various implementations, the system provides the identity information during a moment that is based on one or more predetermined announcement policies. For example, in some implementations, a predetermined announcement policy may be to deliver the identity information immediately upon recognizing the person associated with the voice. In some implementations, a predetermined announcement policy may be to deliver the identity information at a delayed time (e.g., during a conversation break, etc.). For example, the system may provide the identity information when the system hears silence such as a break in the conversation between the user and another person. This enables the system to avoid interfering with the conversations.

In some implementations, the system may attenuate or filter particular sounds that might not be important for the user to hear. For example, the system may attenuate background noise such as wind, traffic, etc. This enables the user to more easily distinguish between important sounds (e.g., alarms, notifications, announcements, etc.) from less important sounds (e.g., wind, traffic, etc.). The system may utilize any suitable frequency attenuation or noise cancelation techniques.

In some implementations, where the user is wearing a hearing aid in both ears, the system may deliver alarms, notifications, announcements, etc. to the user in the hearing aid of one ear and not the other hearing aid. This enables the system to deliver different types of information simultaneously. In such scenarios, the system may increase the volume of alarms, notifications, and announcements to be at higher level than other ambient sounds.

As indicated above, the system may establish communication between the hearing aid and a mobile device, and also access an Internet via the mobile device. As such, the system enables the hearing aid to send and receive data to and from the Internet via the mobile device. This is beneficial in that the hearing aid may utilize the power and other resources of the mobile device.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations provide cognitive help using speaker recognition. Implementations described herein also identify voices and provide identity information associated with such voices.

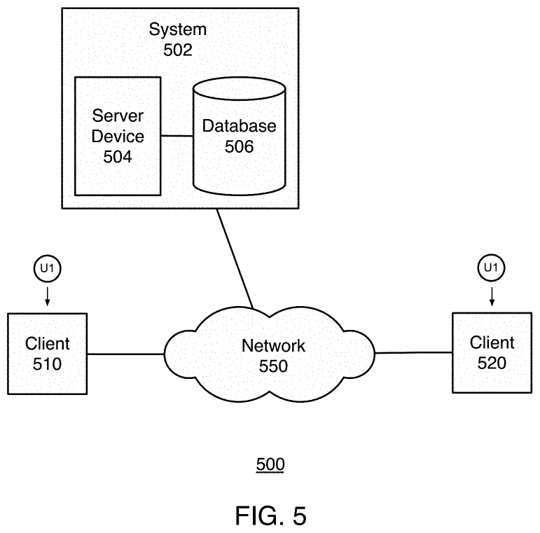

FIG. 5 is a block diagram of an example network environment 500, which may be used for some implementations described herein. In some implementations, network environment 500 includes a system 502, which includes a server device 504 and a database 506. For example, system 502 may be used to implement a system of a mobile device that communicates with the hearing aid described herein, as well as to perform implementations described herein.

Network environment 500 also includes client devices 510 and 520, which may represent two hearing aids worn by a user U1. For example, one client device may represent a hearing aid for a right ear, and the other client device may represent a hearing aid for a left ear. Client devices 510 and 520 may communicate with system 502 and/or may communicate with each other directly or via system 502. Network environment 500 also includes a network 550 through which system 502 and client devices 510 and 520 communicate. Network 550 may be any suitable communication network such as a Wi-Fi network, Bluetooth network, the Internet, etc.

While system 502 is shown separately from client devices 510 and 520, variations of system 502 may also be integrated into client device 510 and/or client device 520. This enables each of client devices 510 and 520 to communication directly with the Internet or another network.

For ease of illustration, FIG. 5 shows one block for each of system 502, server device 504, and network database 506. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server device 504 of system 502 performs implementations described herein, in other implementations, any suitable component or combination of components associated with system 502 or any suitable processor or processors associated with system 502 may facilitate performing the implementations described herein.

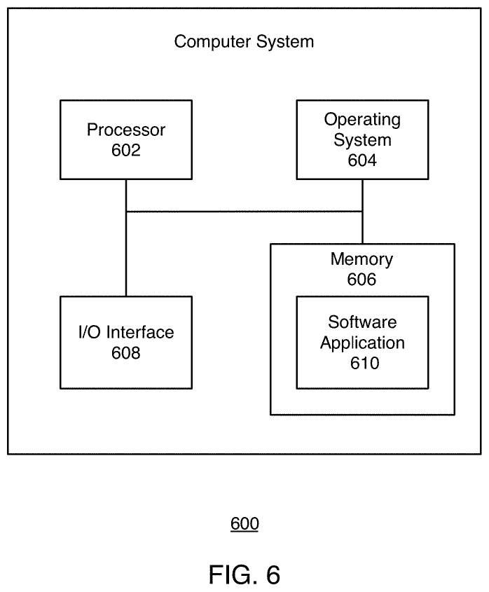

FIG. 6 is a block diagram of an example computer system 600, which may be used for some implementations described herein. For example, computer system 600 may be used to implement server device 504 of FIG. 5 and/or system 102 of FIG. 1, as well as to perform implementations described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application 610 may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular implementations may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular implementations can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
receiving sound at a hearing aid;
detecting a voice from the sound;
identifying the voice; and
providing identity information associated with the voice.

2. The system of claim 1, wherein the logic when executed is further operable to cause the one or more processors to perform operations comprising:
determining characterization information from the voice;
matching the characterization information from the voice to characterization information in a database; and
identifying a person based on the matching.

3. The system of claim 1, wherein the logic when executed is further operable to cause the one or more processors to perform operations comprising:
detecting a plurality of voices from the sound;
identifying a primary voice from the plurality of voices; and
providing the identity information, wherein the identity information is associated with the primary voice.

4. The system of claim 1, wherein the logic when executed is further operable to cause the one or more processors to perform operations comprising:
generating a notification that identifies a person associated with the voice, wherein the notification comprises the identity information; and
providing the identity information in the notification.

5. The system of claim 1, wherein the identity information is provided in an in-ear notification, wherein the in-ear notification is audible to a user of the hearing aid.

6. The system of claim 1, wherein the logic when executed is further operable to cause the one or more processors to perform operations comprising:
establishing communication between the hearing aid and a mobile device; and
accessing an Internet via the mobile device, wherein the hearing aid sends and receives data to and from the Internet via the mobile device.

7. The system of claim 1, wherein the logic when executed is further operable to cause the one or more processors to perform operations comprising identifying one or more voices from the sound in real time based on artificial intelligence.

8. A non-transitory computer-readable storage medium with program instructions stored thereon, the program instructions when executed by one or more processors are operable to cause the one or more processors to perform operations comprising:
receiving sound at a hearing aid;
detecting a voice from the sound;
identifying the voice; and
providing identity information associated with the voice.

9. The computer-readable storage medium of claim 8, wherein the instructions when executed are further operable to cause the one or more processors to perform operations comprising:
determining characterization information from the voice;
matching the characterization information from the voice to characterization information in a database; and
identifying a person based on the matching.

10. The computer-readable storage medium of claim 8, wherein the instructions when executed are further operable to cause the one or more processors to perform operations comprising:
detecting a plurality of voices from the sound;
identifying a primary voice from the plurality of voices; and
providing the identity information, wherein the identity information is associated with the primary voice.

11. The computer-readable storage medium of claim 8, wherein the instructions when executed are further operable to cause the one or more processors to perform operations comprising:
generating a notification that identifies a person associated with the voice, wherein the notification comprises the identity information; and
providing the identity information in the notification.

12. The computer-readable storage medium of claim 8, wherein the identity information is provided in an in-ear notification, wherein the in-ear notification is audible to a user of the hearing aid.

13. The computer-readable storage medium of claim 8, wherein the instructions when executed are further operable to cause the one or more processors to perform operations comprising:
establishing communication between the hearing aid and a mobile device; and
accessing an Internet via the mobile device, wherein the hearing aid sends and receives data to and from the Internet via the mobile device.

14. The computer-readable storage medium of claim 8, wherein the instructions when executed are further operable to cause the one or more processors to perform operations comprising identifying one or more voices from the sound in real time based on artificial intelligence.

15. A computer-implemented method comprising:
receiving sound at a hearing aid;
detecting a voice from the sound;
identifying the voice; and
providing identity information associated with the voice.

16. The method of claim 15, further comprising:
determining characterization information from the voice;
matching the characterization information from the voice to characterization information in a database; and
identifying a person based on the matching.

17. The method of claim 15, further comprising:
detecting a plurality of voices from the sound;
identifying a primary voice from the plurality of voices; and
providing the identity information, wherein the identity information is associated with the primary voice.

18. The method of claim 15, further comprising:
generating a notification that identifies a person associated with the voice, wherein the notification comprises the identity information; and
providing the identity information in the notification.

19. The method of claim 15, wherein the identity information is provided in an in-ear notification, wherein the in-ear notification is audible to a user of the hearing aid.

20. The method of claim 15, further comprising:
establishing communication between the hearing aid and a mobile device; and
accessing an Internet via the mobile device, wherein the hearing aid sends and receives data to and from the Internet via the mobile device.
